(19) United States
(12) Patent Application Publication
(10) Pub. No.: US 2018/0185963 A1
(43) Pub. Date: Jul. 5, 2018

(54) SYSTEMS AND METHODS FOR INTERCHANGABLE ADDITIVE MANUFACTURING SYSTEMS

(71) Applicant: General Electric Company, Schenectady, NY (US)

(72) Inventors: Victor Petrovich Ostroverkhov, Ballston Lake, NY (US); Harry Kirk Mathews, JR., Clifton Park, NY (US); Justin John Gambone, JR., Watervliet, NY (US)

(21) Appl. No.: 15/860,403

(22) Filed: Jan. 2, 2018

Related U.S. Application Data
(60) Provisional application No. 62/441,669, filed on Jan. 3, 2017.

(51) Int. Cl. B23K 26/342; B29C 64/245; B29C 64/25; B33Y 30/00; B29C 64/371; B28B 1/00; B23K 26/082; B23K 26/08; B23K 26/12

(52) U.S. Cl. CPC B23K 26/342; B29C 64/245; B29C 64/25; B33Y 30/00; B29C 64/371; B23K 26/128; B23K 26/082; B23K 26/0838; B23K 26/0853; B23K 26/123; B28B 1/001

(57) ABSTRACT

An additive manufacturing system includes build plate with a powdered metal material disposed thereon. The additive manufacturing system also includes at least one wall defining an air-locked build chamber, a conveyor system, and a plurality of operation stations. The conveyor system is disposed within the air-locked build chamber. The conveyor system is configured to transport the build plate. The plurality of operation stations are positioned adjacent to the conveyor system and within the air-locked build chamber. Each operation station of the plurality of operation stations is configured to facilitate execution of at least one additive manufacturing operation on the powdered metal material disposed on the build plate. The conveyor system is configured to transfer the build plate from a first operation station of the plurality of operation stations to a second operation station of the plurality of operation stations.

### CROSS REFERENCE TO RELATED APPLICATIONS

This application claims priority to U.S. provisional patent application Ser. No. 62/441,669, filed Jan. 3, 2017, which is hereby incorporated by reference in its entirety.

### BACKGROUND

The field of the disclosure relates generally to additive manufacturing systems, and more particularly, to systems and methods for a continuous build process with a shared environment for multiple build areas, a mobile inert gas purging station, and a centralized inert gas purging station for build platform modules.

At least some additive manufacturing systems involve the buildup of a powdered material to make a component. This method can produce complex components from expensive materials at a reduced cost and with improved manufacturing efficiency. At least some known additive manufacturing systems, such as Direct Metal Laser Melting (DMLM) systems, fabricate components using a laser device, a build plate, and a powder material, such as, without limitation, a powdered metal. The laser device generates a laser beam that melts the powder material on the build plate in and around the area where the laser beam is incident on the powder material, resulting in a melt pool. Some known components may require different laser temperatures and different powder materials for different parts of the components. As such, some known components may require multiple DMLM systems to complete the component. Transferring the unfinished component from a first DMLM system to a second DMLM system, can decrease the build time of the component. However, transferring the component to multiple DMLM systems and purging the DMLM systems with inert gas can increase the cost and time to complete a component.

### BRIEF DESCRIPTION

In one aspect, an additive manufacturing system is provided. The additive manufacturing system includes build plate with a powdered metal material disposed thereon. The additive manufacturing system also includes at least one wall defining an air-locked build chamber, a conveyor system, and a plurality of operation stations. The conveyor system is disposed within the air-locked build chamber. The conveyor system is configured to transport the build plate. The plurality of operation stations are positioned adjacent to the conveyor system and within the air-locked build chamber. Each operation station of the plurality of operation stations is configured to facilitate execution of at least one additive manufacturing operation on the powdered metal material disposed on the build plate. The conveyor system is configured to transfer the build plate from a first operation station of the plurality of operation stations to a second operation station of the plurality of operation stations.

In another aspect, a mobile purge station is provided. The mobile purge station is configured to be coupled in flow communication with an additive manufacturing system. The additive manufacturing system includes at least one wall defining an air-locked build chamber. The mobile purge station includes a vessel and a transportation device. The vessel is configured to contain an inert gas. The vessel is coupled in flow communication with the air-locked build chamber. The transportation device is configured to transport the vessel to the additive manufacturing system. The vessel is configured to channel the inert gas into the air-locked build chamber.

In yet another aspect, an additive manufacturing system is provided. The additive manufacturing system includes a laser device, at least one wall defining an air-locked build chamber, a build plate, a first scanning device, and a mobile purge station. The laser device is configured to generate a laser beam. The build plate has a position relative to the laser device. The build plate is disposed within the air-locked build chamber. The first scanning device is configured to selectively direct the laser beam across the build plate. The laser beam generates a melt pool in the build plate. The mobile purge station includes a vessel and a transportation device. The vessel is configured to contain an inert gas. The vessel is coupled in flow communication with the air-locked build chamber. The transportation device is configured to transport the vessel to the air-locked build chamber. The vessel is configured to channel the inert gas into the air-locked build chamber.

In a further aspect, an additive manufacturing facility is provided. The additive manufacturing facility includes at least one mobile build platform module, a centralized inert gas purging station, and at least one additive manufacturing system. The centralized inert gas purging station is configured to purge the at least one mobile build platform module with an inert gas. The at least one additive manufacturing system is configured to build a solid component within the at least one mobile build platform module.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic view of an exemplary multiple build station additive manufacturing system in a linear configuration;

FIG. 2 is a schematic view of an exemplary multiple build station additive manufacturing system in a circular configuration;

FIG. 3 is a schematic view of an exemplary operation station or additive manufacturing system shown in the form of a direct metal laser melting (DMLM) system including an alignment system;

FIG. 4 is a schematic view of an build plate of the additive manufacturing system of FIG. 3;

FIG. 5 is a schematic view of an exemplary additive manufacturing system shown in the form of a direct metal laser melting (DMLM) system including a mobile purge station;

FIG. 6 is an exemplary multiple unit additive manufacturing system with a centralized inert gas purging station;

FIG. 7 is a schematic view of an exemplary additive manufacturing system shown in the form of a direct metal laser melting (DMLM) system including a mobile build plate module and an alignment system; and

FIG. 8 is a schematic view of an build plate of the additive manufacturing system of FIG. 7.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the terms “processor” and “computer” and related terms, e.g., “processing device” and “computing device”, are not limited to just those integrated circuits referred to in the art as a computer, but broadly refers to a microcontroller, a microcomputer, a programmable logic controller (PLC), an application specific integrated circuit, and other programmable circuits, and these terms are used interchangeably herein. In the embodiments described herein, memory may include, but is not limited to, a computer-readable medium, such as a random access memory (RAM), and a computer-readable nonvolatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of the time of occurrence of the associated events, the time of measurement and collection of predetermined data, the time to process the data, and the time of a system response to the events and the environment. In the embodiments described herein, these activities and events occur substantially instantaneously.

Embodiments of the multiple build station additive manufacturing system described herein build a component with multiple build areas in an air-locked chamber. The multiple build area additive manufacturing system includes an air-locked build chamber, a conveyor system, a plurality of operation stations, an air locked input chamber, and an air-locked exit chamber. The operation stations are positioned adjacent to the conveyor system within the air-locked build chamber. A build platform enters the air-locked input chamber and the atmosphere in the air-locked input chamber purged with inert gas. Then the build platform enters the air-locked build chamber and is positioned on the conveyor system. The conveyor system transports the build platform from operational station to operational station. Each operational station performs a task on build powder on the build platform. Once the operation stations have completed a component on the build platform, the build platform exits the air-locked build chamber through the air-locked exit chamber. Building a component with multiple build stations in a single air-locked build chamber decreases build time and costs.

Additionally, embodiments of the mobile purging station described herein purge air-locked build chambers of multiple direct metal laser melting (DMLM) systems. The mobile purging station includes a vessel and a compressor. During operations, the compressor channels an inert gas into the sealed air-locked build chamber. The inert gas displaces the atmospheric oxygen in the air-locked build chamber. After the mobile purge unit has purged a first DMLM system, the mobile purge unit can purge other DMLM systems while the first DMLM system is constructing a component. Mobile purge stations reduce the cost of DMLM systems by eliminating a dedicated purge station on each DMLM system. Additionally, mobile purge stations may have larger, more powerful compressors which can purge the air-locked build chamber faster than a smaller, less powerful dedicated purge station. Thus, mobile purge stations decrease the build time of a component.

Additionally, embodiments of the centralized inert gas purging station for build platform modules described herein purge mobile build platform modules of multiple direct metal laser melting (DMLM) systems. DMLM systems are separated into two chambers with contained gas environments, a mobile build platform module and an integration module. The integration module includes a laser scanner and a powder-dispensing unit. The integration module maintains an inert environment throughout the entire process. During operations, a build plated is loaded into the mobile build platform module. A centralized inert gas purging station purges the mobile build platform module with inert gas. The mobile build platform module is coupled to the integration module and the powder-dispensing unit dispenses powder to a build plate within the mobile build platform module. The laser scanner builds a component in the mobile build platform module and the mobile build platform module is decoupled from the integration module. The centralized inert gas purging station reduces the cost of DMLM systems by eliminating a dedicated purge station on each DMLM system. Additionally, the centralized inert gas purging station may have larger, more powerful compressors which can purge the mobile build platform module faster than a smaller, less powerful dedicated purge station. Thus, the centralized inert gas purging station described herein decreases the build time of a component.

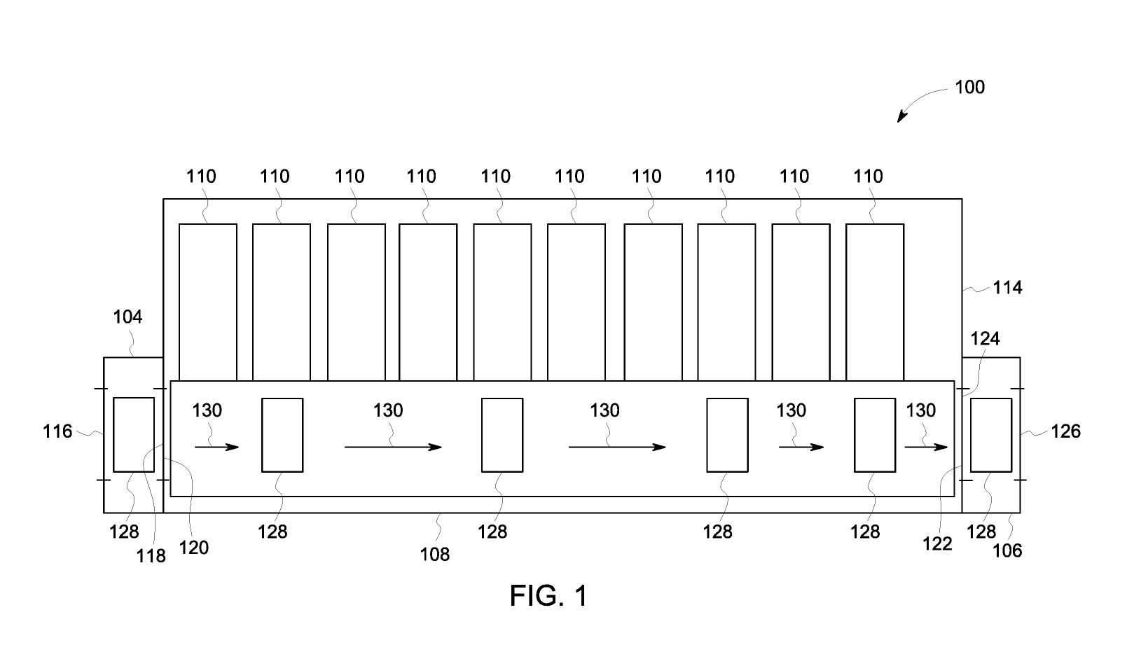

FIG. 1 is a schematic view of an exemplary multiple build station additive manufacturing system or manufacturing system 100 in a linear configuration. Manufacturing system 100 includes an air-locked build chamber 102, an air-locked input chamber 104, an air-locked exit chamber 106, a conveyor system 108, and a plurality of operation stations 110. Operation stations 110 are positioned adjacent to conveyor system 108 within air-locked build chamber 102. Air-locked input chamber 104 is positioned at a first end 112 of air-locked build chamber 102 and air-locked exit chamber 106 is positioned at a second end 114 of air-locked build chamber 102.

Air-locked input chamber 104 includes an input chamber entrance 116 and an input chamber exit 118. Air-locked build chamber 102 includes a build chamber entrance 120 and a build chamber exit 122. Air-locked exit chamber 106 includes an exit chamber entrance 124 and an exit chamber exit 126. Input chamber entrance 116, input chamber exit 118, build chamber entrance 120, build chamber exit 122, exit chamber entrance 124, and exit chamber exit 126 all include doors which allow for transfer of material into and out of air-locked input chamber 104, air-locked build chamber 102, and air-locked exit chamber 106. In the exemplary embodiment, input chamber exit 118 and build chamber entrance 120 are the same entrance and exit. However, in another embodiment (not shown), input chamber exit 118 and build chamber entrance 120 may be different entrances and exits. Similarly, in the exemplary embodiment, build chamber exit 122 and exit chamber entrance 124 are the same entrance and exit. However, in another embodiment (not shown), build chamber exit 122 and exit chamber entrance 124 may be different entrances and exits.

Air-locked input chamber, build chamber, and exit chamber 102, 104, and 106 are configured to have the atmosphere within air-locked input chamber, build chamber, and exit chamber 102, 104, and 106 purged with an inert gas. In the exemplary embodiment, air-locked input chamber, build chamber, and exit chamber 102, 104, and 106 are purged with argon. However, air-locked input chamber, build chamber, and exit chamber 102, 104, and 106 may be purged with any inert gas which enables manufacturing system 100 to operate as described herein.

In the exemplary embodiment, conveyor system 108 includes a conveyor belt configured to transfer material from operating station 110 to operating station 110. Conveyor system 108 is not limited to include a conveyor belt system. Rather, conveyor system 108 may include any conveyance mechanism which enables manufacturing system 100 to operate as described herein.

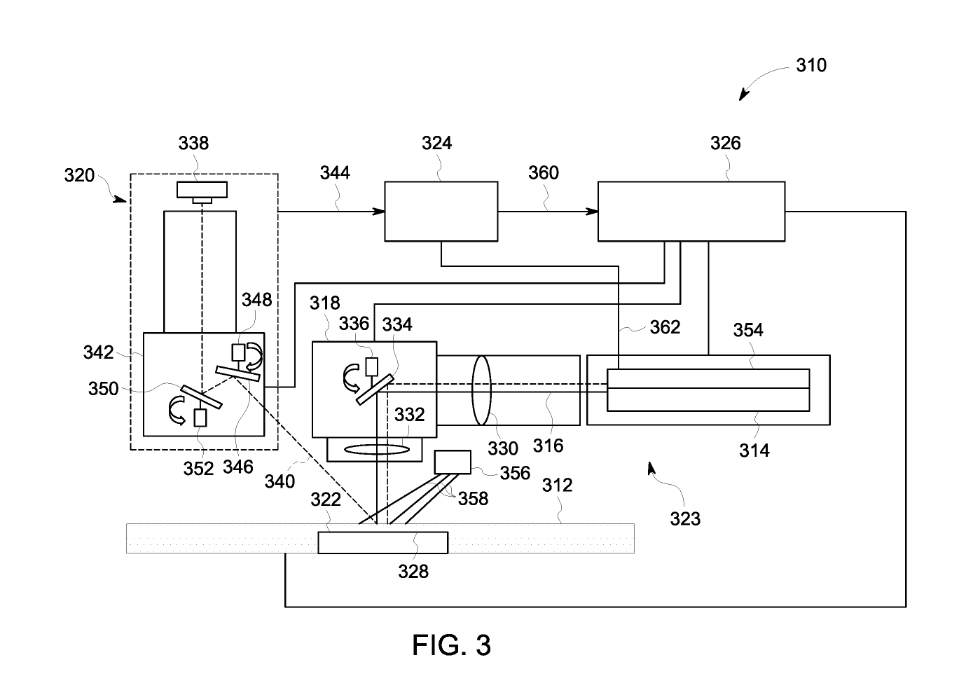

In the exemplary embodiment, operation stations 110 include an additive manufacturing system 310 (see FIG. 3). Operation stations 110 may include any operation which enables manufacturing system 100 to operate as described herein including, without limitation, powder spreading, laser melting (contour, hatch, extra treatment), inspection, powder removal, heat treatment, or machining. Manufacturing system 100 may perform the listed operations in any sequence which enables manufacturing system 100 to operate as described herein.

During operations, air-locked build chamber 102 is purged with argon. Input chamber entrance 116 is opened and a build plate 128 with a powdered build material (not shown) is transferred into air-locked input chamber 104. Air-locked input chamber 104 is purged with argon. Input chamber exit 118 and build chamber entrance 120 are opened and a build plate 128 is transferred into air-locked build chamber 102 and onto conveyor system 108. Conveyor system 108 transfers build plate 128 from operation station 110 to operation station 110 in a direction 130 from first end 112 of air-locked build chamber 102 to second end 114 of air-locked build chamber 102. Once conveyance system 108 has transferred build plate 128 to the last operation station 110, build chamber exit 122 and exit chamber entrance 124 are opened and build plate 128 is transferred into air-locked exit chamber 106. Then exit chamber entrance 124 is closed. Finally, exit chamber exit 126 is opened and build plate 128 is transferred out of air-locked exit chamber 106.

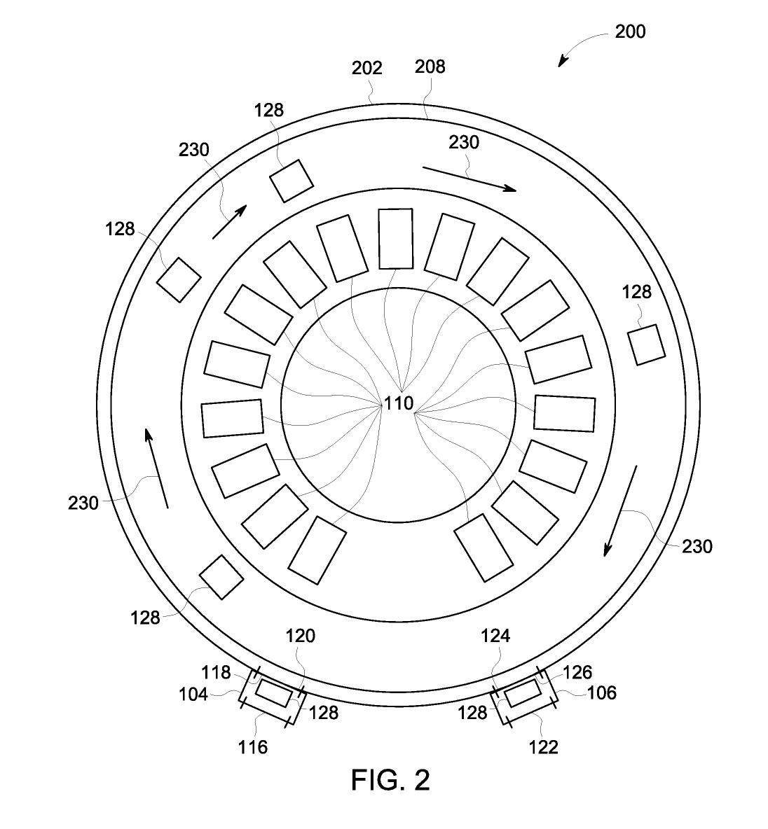

FIG. 2 is a schematic view of another exemplary multiple build station additive manufacturing system or manufacturing system 200 in a circular configuration. Manufacturing system 200 includes all the same parts as manufacturing system 100 except that manufacturing system 200 includes a circular air-locked build chamber 202 rather than air-locked build chamber 102 and a circular conveyor system 208 rather than conveyor system 108. During operations, build plate 128 is transferred to different operation stations 110 in a circumferential direction 230 rather than a linear direction such as direction 130.

FIG. 3 is a schematic view of an exemplary operation station or additive manufacturing system 310 illustrated in the form of a direct metal laser melting (DMLM) system. Although the embodiments herein are described with reference to a DMLM system, this disclosure may also apply to other types of additive manufacturing systems, such as selective laser sintering systems.

In the exemplary embodiment, DMLM system 310 includes a build plate 312, a laser device 314 configured to generate a laser beam 316, a first scanning device 318 configured to selectively direct laser beam 316 across build plate 312, an optical system 320 for monitoring a melt pool 322 created by laser beam 316, and an alignment system 323. The exemplary DMLM system 310 also includes a computing device 324 and a controller 326 configured to control one or more components of DMLM system 310, as described in more detail herein.

Build plate 312 includes a powdered build material that is melted and re-solidified during the additive manufacturing process to build a solid component 328. The powdered build material includes materials suitable for forming such components, including, without limitation, gas atomized alloys of cobalt, iron, aluminum, titanium, nickel, and combinations thereof. In other embodiments, the powdered build material may include any suitable type of powdered metal material. In yet other embodiments, the powdered build material may include any suitable build material that enables DMLM system 310 to function as described, including, for example and without limitation, ceramic powders, metal-coated ceramic powders, and thermoset or thermoplastic resins.

Laser device 314 is configured to generate a laser beam 316 of sufficient energy to at least partially melt the build material of build plate 312. In the exemplary embodiment, laser device 314 is a yttrium-based solid state laser configured to emit a laser beam having a wavelength of about 1070 nanometers (nm). In another embodiment, laser device 314 is a multi-laser diode array including fiber lasers. In other embodiments, laser device 314 may include any suitable type of laser that enables DMLM system 310 to function as described herein, such as a CO₂ laser. Further, although DMLM system 310 is shown and described as including a single laser device 314, DMLM system 310 may include more than one laser device. In one embodiment, for example, DMLM system 310 may include a first laser device having a first power and a second laser device having a second power different from the first laser power, or at least two laser devices having substantially the same power output. In yet other embodiments, DMLM system 310 may include any combination of laser devices that enable DMLM system 310 to function as described herein.

As shown in FIG. 3, laser device 314 is optically coupled to optical elements 330 and 332 that facilitate focusing laser beam 316 on build plate 312. In the exemplary embodiment, optical elements 330 and 332 include a beam collimator 330 disposed between the laser device 314 and first scanning device 318, and an F-theta lens 332 disposed between the first scanning device 318 and build plate 312. In other embodiments, DMLM system 310 may include any suitable type and arrangement of optical elements that provide a collimated and/or focused laser beam on build plate 312.

First scanning device 318 is configured to direct laser beam 316 across selective portions of build plate 312 to create solid component 328. In the exemplary embodiment, first scanning device 318 is a galvanometer scanning device including a mirror 34 operatively coupled to a galvanometer-controlled motor 336 (broadly, an actuator). Motor 336 is configured to move (specifically, rotate) mirror 334 in response to signals received from controller 326, and thereby deflect laser beam 316 across selective portions of build plate 312. Mirror 334 may have any suitable configuration that enables mirror 334 to deflect laser beam 316 towards build plate 312. In some embodiments, mirror 334 may include a reflective coating that has a reflectance spectrum that corresponds to the wavelength of laser beam 316.

Although first scanning device 318 is illustrated with a single mirror 334 and a single motor 336, first scanning device 318 may include any suitable number of mirrors and motors that enable first scanning device 318 to function as described herein. In one embodiment, for example, first scanning device 318 includes two mirrors and two galvanometer-controlled motors, each operatively coupled to one of the mirrors. In yet other embodiments, first scanning device 318 may include any suitable scanning device that enables DMLM system 310 to function as described herein, such as, for example, two-dimension (2D) scan galvanometers, three-dimension (3D) scan galvanometers, and dynamic focusing galvanometers.

Optical system 320 is configured to detect electromagnetic radiation generated by melt pool 322 and transmit information about melt pool 322 to computing device 324. In the exemplary embodiment, optical system 320 includes an first optical detector 338 configured to detect electromagnetic radiation 340 (also referred to as “EM radiation”) generated by melt pool 322, and a second scanning device 3 42 configured to direct EM radiation 340 to first optical detector 338. More specifically, first optical detector 338 is configured to receive EM radiation 340 generated by melt pool 322, and generate an electrical signal 344 in response thereto. First optical detector 338 is communicatively coupled to computing device 324, and is configured to transmit electrical signal 344 to computing device 324.

First optical detector 338 may include any suitable optical detector that enables optical system 320 to function as described herein, including, for example and without limitation, a photomultiplier tube, a photodiode, an infrared camera, a charged-couple device (CCD) camera, a CMOS camera, a pyrometer, or a high-speed visible-light camera. Although optical system 320 is shown and described as including a single first optical detector 338, optical system 320 may include any suitable number and type of optical detectors that enables DMLM system 310 to function as described herein. In one embodiment, for example, optical system 320 includes a first optical detector configured to detect EM radiation within an infrared spectrum, and a second optical detector configured to detect EM radiation within a visible-light spectrum. In embodiments including more than one optical detector, optical system 320 may include a beam splitter (not shown) configured to divide and deflect EM radiation 340 from melt pool 322 to a corresponding optical detector.

While optical system 320 is described as including “optical” detectors for EM radiation 340 generated by melt pool 322, it should be noted that use of the term “optical” is not to be equated with the term “visible.” Rather, optical system 320 may be configured to capture a wide spectral range of EM radiation. For example, first optical detector 338 may be sensitive to light with wavelengths in the ultraviolet spectrum (about 200-400 nm), the visible spectrum (about 400-700 nm), the near-infrared spectrum (about 700-1,200 nm), and the infrared spectrum (about 1,200-10,000 nm). Further, because the type of EM radiation emitted by melt pool 322 depends on the temperature of melt pool 322, optical system 320 is capable of monitoring and measuring both a size and a temperature of melt pool 322.

Second scanning device 342 is configured to direct EM radiation 340 generated by melt pool 322 to first optical detector 338. In the exemplary embodiment, second scanning device 342 is a galvanometer scanning device including a first mirror 346 operatively coupled to a first galvanometer-controlled motor 348 (broadly, an actuator), and a second mirror 350 operatively coupled to a second galvanometer-controlled motor 352 (broadly, an actuator). First motor 348 and second motor 352 are configured to move (specifically, rotate) first mirror 346 and second mirror 350, respectively, in response to signals received from controller 326 to deflect EM radiation 340 from melt pool 322 to first optical detector 338. First mirror 346 and second mirror 350 may have any suitable configuration that enables first mirror 346 and second mirror 350 to deflect EM radiation 340 generated by melt pool 322. In some embodiments, one or both of first mirror 346 and second mirror 350 includes a reflective coating that has a reflectance spectrum that corresponds to EM radiation that first optical detector 338 is configured to detect.

Although second scanning device 342 is illustrated and described as including two mirrors and two motors, second scanning device 342 may include any suitable number of mirrors and motors that enable optical system 320 to function as described herein. Further, second scanning device 342 may include any suitable scanning device that enables optical system 320 to function as described herein, such as, for example, two-dimension (2D) scan galvanometers, three-dimension (3D) scan galvanometers, and dynamic focusing galvanometers.

Build plate 312 is configured to operate with multiple DMLM systems 310. In the exemplary embodiment, a first DMLM system 310 manufactures a first part of solid component 328 and a second DMLM system 310 manufactures a second part of solid component 328. Build plate 312 is moved from first DMLM system 310 to second DMLM system 310 with solid component 328 on build plate 312. Build plate 312 must be aligned with second DMLM system 310.

Alignment system 323 is configured to align build plate 312 with DMLM system 310. Alignment system 323 includes a second optical detector 354 and a fiducial marks projector 356. Fiducial marks projector 356 projects a plurality of fiducial marks 358 on build plate 312. In the exemplary embodiment, fiducial marks projector 356 projects three fiducial marks 358. However, fiducial marks projector 356 may project any number of fiducial marks 358 which enables alignment system 323 to operate as described herein. Each fiducial mark 358 includes a shape projected onto build plate 312 by fiducial marks projector 356. Fiducial marks projector 356 includes a plurality of lasers (not shown) which project fiducial marks 358 onto build plate 312.

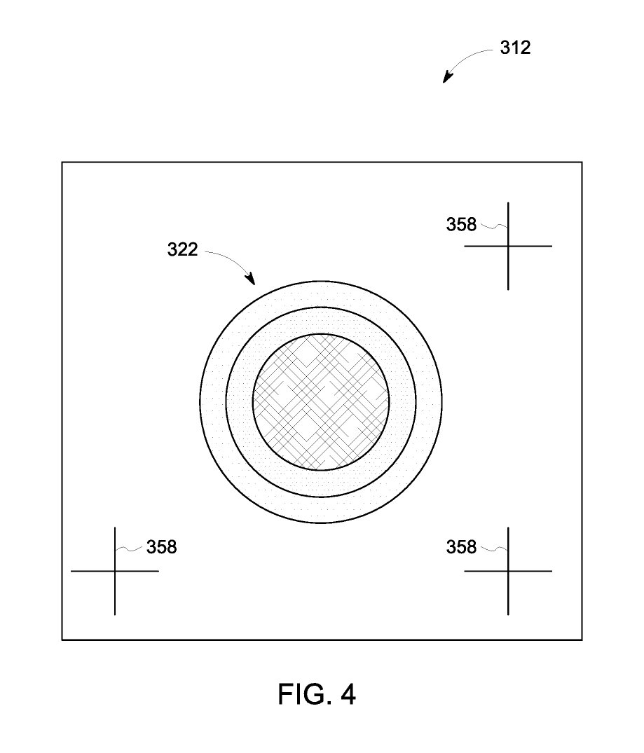

FIG. 4 is a schematic view of build plate 312 of DMLM system 310. In the exemplary embodiment, build plate 312 has a rectangular shape. In other embodiments, build plate 312 may have any suitable size and shape that enables DMLM system 310 to function as described herein. Fiducial marks 358 are projected onto build plate 312. In the exemplary embodiment, fiducial marks 358 have a cross shape. In other embodiments, the shape of fiducial marks 358 may include a circle shape, a triangle shape, or any shape which enables alignment system 323 to operate as described herein. Additionally, fiducial marks 358 may include a grid pattern, a pattern of dots, a checkerboard pattern, or any other pattern which enables alignment system 323 to operate as described herein. Fiducial marks 358 are moveable along build plate 312. More specifically, the position of fiducial marks 358 can be adjusted using fiducial marks projector 356. Additionally, the size and shape of fiducial marks projector 356 may be adjusted using fiducial marks projector 356.

As shown in FIG. 3, second optical detector 354 is configured to detect the position of fiducial marks 358 on build plate 312, and generate an electrical signal 362 in response thereto. Second optical detector 354 is configured to detect the position of fiducial marks 358 on build plate 312 through first scanning device 318 while fiducial marks projector 356 does not project fiducial marks 358 through first scanning device 318. Second optical detector 354 is aligned with laser beam 316. Thus, second optical detector 354 detects the position of build plate 312 relative to DMLM system 310. Second optical detector 354 is communicatively coupled to computing device 324, and is configured to transmit electrical signal 362 to computing device 324. Computing device 324 generates a control signal 360 to controller 326 which controls the alignment of build plate 312 within DMLM system 310, the alignment of first scanning device 318, and alignment of mirror 334. Controller 326 aligns build plate in response to the position of fiducial marks 358 by changing the position of build plate 312, first scanning device 318, and mirror 334. Thus, build plate 312 is capable of moving to, and alignment within, different DMLM systems 310.

In the exemplary embodiment, second optical detector 354 is coupled to laser device 314 such that second optical detector 354 observes fiducial marks 358 relative to laser device 314. Additionally, fiducial marks projector 356 is coupled to build plate 312 such that fiducial marks 358 are projected onto build plate 312 at the same location. In another embodiment, second optical detector 354 is coupled to build plate 312 such that second optical detector 354 observes fiducial marks 358 relative to build plate 312. Additionally, fiducial marks projector 356 is coupled to laser device 314 such that fiducial marks 358 are projected onto build plate 312 at the same location relative to laser device 314.

Computing device 324 may be a computer system that includes at least one processor (not shown in FIG. 1) that executes executable instructions to operate DMLM system 310. Computing device 324 may include, for example, a calibration model of DMLM system 310 and an electronic computer build file associated with a component, such as component 328. The calibration model may include, without limitation, an expected or desired melt pool size and temperature under a given set of operating conditions (e.g., a power of laser device 314) of DMLM system 310. The build file may include build parameters that are used to control one or more components of DMLM system 310. Build parameters may include, without limitation, a power of laser device 314, a scan speed of first scanning device 318, a position and orientation of first scanning device 318 (specifically, mirror 334), a scan speed of second scanning device 342, and a position and orientation of second scanning device 342 (specifically, first mirror 346 and second mirror 350). In the exemplary embodiment, computing device 324 and controller 326 are shown as separate devices. In other embodiments, computing device 324 and controller 326 may be combined as a single device that operates as both computing device 324 and controller 326 as each are described herein.

In the exemplary embodiment, computing device 324 is also configured to operate at least partially as a data acquisition device and to monitor the operation of DMLM system 310 during fabrication of component 328. In one embodiment, for example, computing device 324 receives and processes electrical signals 344 from first optical detector 338. Computing device 324 may store information associated with melt pool 322 based on electrical signals 344, which may be used to facilitate controlling and refining a build process for DMLM system 310 or for a specific component built by DMLM system 310.

Further, computing device 324 may be configured to adjust one or more build parameters in real-time based on electrical signals 344 received from first optical detector 338. For example, as DMLM system 310 builds component 328, computing device 324 processes electrical signals 344 from first optical detector 338 using data processing algorithms to determine the size and temperature of melt pool 322. Computing device 324 may compare the size and temperature of melt pool 322 to an expected or desired melt pool size and temperature based on a calibration model. Computing device 324 may generate control signals 360 that are fed back to controller 326 and used to adjust one or more build parameters in real-time to correct discrepancies in melt pool 322. For example, where computing device 324 detects discrepancies in melt pool 322, computing device 324 and/or controller 326 may adjust the power of laser device 314 during the build process to correct such discrepancies.

Controller 326 may include any suitable type of controller that enables DMLM system 310 to function as described herein. In one embodiment, for example, controller 326 is a computer system that includes at least one processor and at least one memory device that executes executable instructions to control the operation of DMLM system 310 based at least partially on instructions from human operators. Controller 326 may include, for example, a 3D model of component 328 to be fabricated by DMLM system 310. Executable instructions executed by controller 326 may include controlling the power output of laser device 314, controlling a position and scan speed of first scanning device 318, and controlling a position and scan speed of second scanning device 342.

Controller 326 is configured to control one or more components of DMLM system 310 based on build parameters associated with a build file stored, for example, within computing device 324. In the exemplary embodiment, controller 326 is configured to control first scanning device 318 based on a build file associated with a component to be fabricated with DMLM system 310. More specifically, controller 326 is configured to control the position, movement, and scan speed of mirror 334 using motor 336 based upon a predetermined path defined by a build file associated with component 328.

In the exemplary embodiment, controller 326 is also configured to control second scanning device 342 to direct EM radiation 340 from melt pool 322 to first optical detector 338. Controller 326 is configured to control the position, movement, and scan speed of first mirror 346 and second mirror 350 based on at least one of the position of mirror 334 of first scanning device 318 and the position of melt pool 322. In one embodiment, for example, the position of mirror 334 at a given time during the build process is determined, using computing device 324 and/or controller 326, based upon a predetermined path of a build file used to control the position of mirror 334. Controller 326 controls the position, movement, and scan speed of first mirror 346 and second mirror 350 based upon the determined position of mirror 334. In another embodiment, first scanning device 318 may be configured to communicate the position of mirror 334 to controller 326 and/or computing device 324, for example, by outputting position signals to controller 326 and/or computing device 324 that correspond to the position of mirror 334. In yet another embodiment, controller 326 controls the position, movement, and scan speed of first mirror 346 and second mirror 350 based on the position of melt pool 322. The location of melt pool 322 at a given time during the build process may be determined, for example, based upon the position of mirror 334.

Controller 326 may also be configured to control other components of DMLM system 310, including, without limitation, laser device 314. In one embodiment, for example, controller 326 controls the power output of laser device 314 based on build parameters associated with a build file.

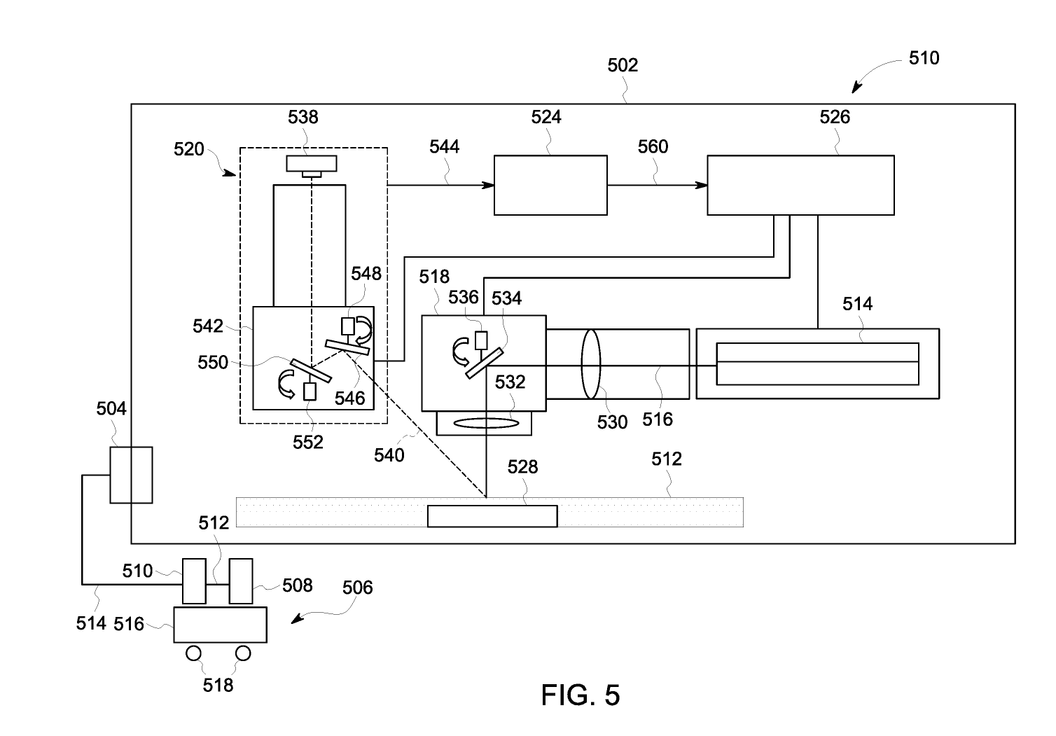

FIG. 5 is a schematic view of an exemplary additive manufacturing system 510 with a mobile purge station 506 illustrated in the form of a direct metal laser melting (DMLM) system. Although the embodiments herein are described with reference to a DMLM system, this disclosure may also apply to other types of additive manufacturing systems, such as selective laser sintering systems. Unless otherwise indicated, components of DMLM system 510 are substantially similar to components of DMLM system 310 (shown in FIG. 3).

In the exemplary embodiment, DMLM system 510 includes a build plate 512, a laser device 514 configured to generate a laser beam 516, a first scanning device 518 configured to selectively direct laser beam 516 across build plate 512, an optical system 520 for monitoring a melt pool (not shown) created by laser beam 516, and a mobile purge station 506. The exemplary DMLM system 510 also includes a computing device 524 and a controller 526 configured to control one or more components of DMLM system 510, as described in more detail herein.

An air-locked build chamber 502 encloses DMLM system 510. Air-locked build chamber 502 is configured to have the atmosphere within air-locked build chamber 502 purged with an inert gas. In the exemplary embodiment, the inert gas is argon. However, air-locked build chamber 502 may be purged with any inert gas which enables DMLM system 510 to operate as described herein. Air-locked build chamber 502 includes a connector 504 configured to channel inert gas into air-locked build chamber 502.

In the exemplary embodiment, a mobile purge station 506 purges air-locked build chamber 502 with an inert gas. Mobile purge station 506 includes a vessel 508 and a compressor 511. Vessel 508 is coupled in flow communication with compressor 511 by a first hose 513. Compressor 511 is coupled in flow communication with connector 504 by a second hose 515. Mobile purge station 506 further includes a transportation device 517 configured to transport compressor 511 and vessel 508 to different DMLM systems 510. In the exemplary embodiment, transportation device 517 includes a cart 516 with a plurality of wheels 519. However, transportation device 517 may include any method of transportation which enables DMLM system 510 to operate as described herein. In the exemplary embodiment, vessel 508 includes an argon gas cylinder. However, vessel 508 may include any source of inert gas which enables DMLM system 510 to operate as described herein.

In another embodiment, mobile purge station 506 does not include compressor 511. Rather, the pressure of the inert gas within vessel 508 is adequate to purge air-locked build chamber 502. Using compressor 511 to purge air-locked build chamber 502 decreases the purge time of air-locked build chamber 502 and decreases the build time of a solid component 528.

During operations, build plate 512 is placed in air-locked build chamber 502 and air-locked build chamber 502 is sealed. Mobile purge station 506 is transported to DMLM system 510. First hose 513 is connected to vessel 508 and compressor 511. Second hose 515 is connected to connector 504 and compressor 511. First hose 513 channels inert gas from vessel 508 to compressor 511. Compressor 511 compresses inert gas from vessel 508. Second hose 515 channels the compressed inert gas from compressor 511 to connector 504 which channels compressed inert gas into air-locked build chamber 502.

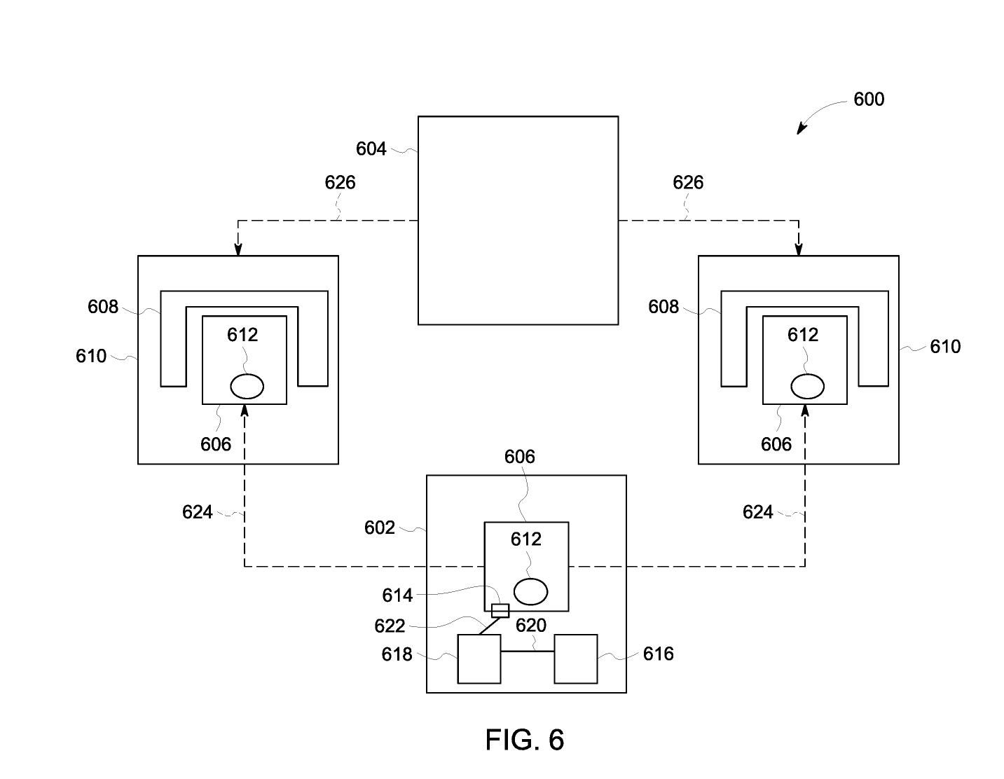

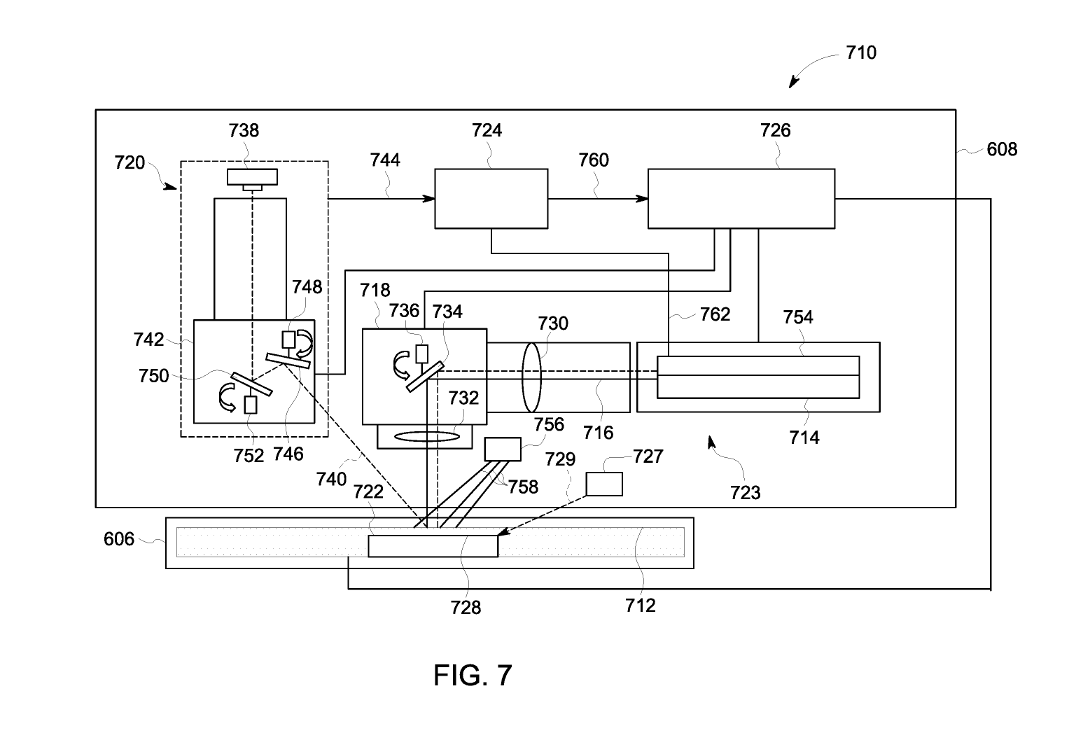

FIG. 6 is a schematic view of an exemplary multiple unit additive manufacturing system 600 with a centralized inert gas purging station 602. Multiple unit additive manufacturing system 600 includes centralized inert gas purging station 602, a plurality of additive manufacturing systems 610, and a central powder distribution system 604. Centralized inert gas purging station 602 is configured to purge a mobile build platform module 606 with inert gas. Additive manufacturing systems 610 includes an integration module 608 which is configured to build a solid component 628 within mobile build platform module 606. Mobile build platform module 606 is configured to interface with integration module 608. Central powder distribution system 604 is configured to transfer a powdered build material (see FIG. 7) to integration module 608 which, in turn, is configured to transfer the powdered build material to mobile build platform module 606.

Mobile build platform module 606 encloses a build plate 612. In the exemplary embodiment, mobile build platform 606 includes a transparent box. However, mobile build platform module 606 may include any shape which enables multiple unit additive manufacturing system 600 to operate as described herein. Mobile build platform module 606 is configured to have the atmosphere within mobile build platform module 606 purged with an inert gas. In the exemplary embodiment, the inert gas is argon. However, mobile build platform module 606 may be purged with any inert gas which enables multiple unit additive manufacturing system 600 to operate as described herein. Mobile build platform module 606 includes a connector 614 configured to channel inert gas into mobile build platform module 606.

In the exemplary embodiment, centralized inert gas purging station 602 purges mobile build platform module 606 with an inert gas. Centralized inert gas purging station 602 includes a source of inert gas 616 and a compressor 618. Source of inert gas 616 is coupled in flow communication with compressor 618 by a first hose 620. Compressor 618 is coupled in flow communication with connector 614 by a second hose 622. In the exemplary embodiment, source of inert gas 616 includes an argon gas cylinder. However, source of inert gas 616 may include any source of inert gas which enables multiple unit additive manufacturing system 600 to operate as described herein.

In another embodiment, centralized inert gas purging station 602 does not include compressor 618. Rather, the pressure of the inert gas within source of inert gas 616 is adequate to purge mobile build platform module 606. Using compressor 618 to purge mobile build platform module 606 decreases the purge time of mobile build platform module 606 and decreases the build time of a solid component 728 (see FIG. 7).

During operations, build plate 612 is placed in mobile build platform module 606 and mobile build platform module 606 is sealed. Mobile build platform module 606 is transported to centralized inert gas purging station 602. First hose 620 is connected to source of inert gas 616 and compressor 618. Second hose 622 is connected to connector 614 and compressor 618. First hose 620 channels inert gas from source of inert gas 616 to compressor 618. Compressor 618 compresses inert gas from source of inert gas 16. Second hose 622 channels the compressed inert gas from compressor 618 to connector 614 which channels compressed inert gas into mobile build platform module 606.

After centralized inert gas purging station 602 purges mobile build platform module 606 with inert gas, mobile build platform module 606 is transferred to additive manufacturing systems 610 as indicated by arrows 624. Mobile build platform module 606 then is coupled to integration module 608. Central powder distribution system 604 transfers the powdered build material to integration module 608 as indicated by arrows 626. Integration module 608 then transfers the powdered build material to build plate 612 within mobile build platform module 606. Additive manufacturing systems 610 then builds solid component 728 in mobile build platform module 606. Finally, mobile build platform module 606 is decoupled from additive manufacturing systems 610.

FIG. 7 is a schematic view of an exemplary additive manufacturing system 710 with another embodiment of an alignment system 723 illustrated in the form of a direct metal laser melting (DMLM) system. Although the embodiments herein are described with reference to a DMLM system, this disclosure may also apply to other types of additive manufacturing systems, such as selective laser sintering systems.

In the exemplary embodiment, DMLM system 710 includes a build plate 712, a laser device 714 configured to generate a laser beam 716, a first scanning device 718 configured to selectively direct laser beam 716 across build plate 712, an optical system 720 for monitoring a melt pool 722 created by laser beam 716, and an alignment system 723. The exemplary DMLM system 710 also includes a computing device 724 and a controller 726 configured to control one or more components of DMLM system 710, as described in more detail herein.

In the exemplary embodiment, DMLM system 710 is contained within integration module 608 except for build plate 712 which is contained within mobile build platform module 606. Integration module 608 has been purged with an inert gas. Integration module 608 maintains an inert environment throughout the entire additive manufacturing process. DMLM system 710 includes a powder-dispensing unit 727 which is configured to receive powdered build material from Central powder distribution system 604 and to dispense powdered build material to build plate 712 as indicated by arrow 729.

Build plate 712 receives powdered build material which is melted and re-solidified during the additive manufacturing process to build solid component 728. The powdered build material includes materials suitable for forming such components, including, without limitation, gas atomized alloys of cobalt, iron, aluminum, titanium, nickel, and combinations thereof. In other embodiments, the powdered build material may include any suitable type of powdered metal material. In yet other embodiments, the powdered build material may include any suitable build material that enables DMLM system 710 to function as described, including, for example and without limitation, ceramic powders, metal-coated ceramic powders, and thermoset or thermoplastic resins.

Laser device 714 is configured to generate a laser beam 716 of sufficient energy to at least partially melt the build material of build plate 712. In the exemplary embodiment, laser device 714 is a yttrium-based solid state laser configured to emit a laser beam having a wavelength of about 1070 nanometers (nm). In another embodiment, laser device 714 is a multi-laser diode array including fiber lasers. In other embodiments, laser device 714 may include any suitable type of laser that enables DMLM system 710 to function as described herein, such as a CO₂ laser. Further, although DMLM system 710 is shown and described as including a single laser device 714, DMLM system 710 may include more than one laser device. In one embodiment, for example, DMLM system 710 may include a first laser device having a first power and a second laser device having a second power different from the first laser power, or at least two laser devices having substantially the same power output. In yet other embodiments, DMLM system 710 may include any combination of laser devices that enable DMLM system 710 to function as described herein.

As shown in FIG. 7, laser device 714 is optically coupled to optical elements 730 and 732 that facilitate focusing laser beam 716 on build plate 712. In the exemplary embodiment, optical elements 730 and 732 include a beam collimator 730 disposed between the laser device 714 and first scanning device 718, and an F-theta lens 732 disposed between the first scanning device 718 and build plate 712. In other embodiments, DMLM system 710 may include any suitable type and arrangement of optical elements that provide a collimated and/or focused laser beam on build plate 712.

First scanning device 718 is configured to direct laser beam 716 across selective portions of build plate 712 to create solid component 728. In the exemplary embodiment, first scanning device 718 is a galvanometer scanning device including a mirror 734 operatively coupled to a galvanometer-controlled motor 736 (broadly, an actuator). Motor 736 is configured to move (specifically, rotate) mirror 734 in response to signals received from controller 726, and thereby deflect laser beam 716 across selective portions of build plate 712. Mirror 734 may have any suitable configuration that enables mirror 734 to deflect laser beam 716 towards build plate 712. In some embodiments, mirror 734 may include a reflective coating that has a reflectance spectrum that corresponds to the wavelength of laser beam 716.

Although first scanning device 718 is illustrated with a single mirror 734 and a single motor 736, first scanning device 718 may include any suitable number of mirrors and motors that enable first scanning device 718 to function as described herein. In one embodiment, for example, first scanning device 718 includes two mirrors and two galvanometer-controlled motors, each operatively coupled to one of the mirrors. In yet other embodiments, first scanning device 718 may include any suitable scanning device that enables DMLM system 710 to function as described herein, such as, for example, two-dimension (2D) scan galvanometers, three-dimension (3D) scan galvanometers, and dynamic focusing galvanometers.

Optical system 720 is configured to detect electromagnetic radiation generated by melt pool 722 and transmit information about melt pool 722 to computing device 724. In the exemplary embodiment, optical system 720 includes an first optical detector 738 configured to detect electromagnetic radiation 740 (also referred to as “EM radiation”) generated by melt pool 722, and a second scanning device 742 configured to direct EM radiation 740 to first optical detector 738. More specifically, first optical detector 738 is configured to receive EM radiation 740 generated by melt pool 722, and generate an electrical signal 744 in response thereto. First optical detector 738 is communicatively coupled to computing device 724, and is configured to transmit electrical signal 744 to computing device 724.

First optical detector 738 may include any suitable optical detector that enables optical system 720 to function as described herein, including, for example and without limitation, a photomultiplier tube, a photodiode, an infrared camera, a charged-couple device (CCD) camera, a CMOS camera, a pyrometer, or a high-speed visible-light camera. Although optical system 720 is shown and described as including a single first optical detector 738, optical system 720 may include any suitable number and type of optical detectors that enables DMLM system 710 to function as described herein. In one embodiment, for example, optical system 720 includes a first optical detector configured to detect EM radiation within an infrared spectrum, and a second optical detector configured to detect EM radiation within a visible-light spectrum. In embodiments including more than one optical detector, optical system 720 may include a beam splitter (not shown) configured to divide and deflect EM radiation 740 from melt pool 722 to a corresponding optical detector.

While optical system 720 is described as including “optical” detectors for EM radiation 740 generated by melt pool 722, it should be noted that use of the term “optical” is not to be equated with the term “visible.” Rather, optical system 720 may be configured to capture a wide spectral range of EM radiation. For example, first optical detector 738 may be sensitive to light with wavelengths in the ultraviolet spectrum (about 200-400 nm), the visible spectrum (about 400-700 nm), the near-infrared spectrum (about 700-1,200 nm), and the infrared spectrum (about 1,200-10,000 nm). Further, because the type of EM radiation emitted by melt pool 722 depends on the temperature of melt pool 722, optical system 720 is capable of monitoring and measuring both a size and a temperature of melt pool 722.

Second scanning device 742 is configured to direct EM radiation 740 generated by melt pool 722 to first optical detector 738. In the exemplary embodiment, second scanning device 742 is a galvanometer scanning device including a first mirror 746 operatively coupled to a first galvanometer-controlled motor 748 (broadly, an actuator), and a second mirror 750 operatively coupled to a second galvanometer-controlled motor 752 (broadly, an actuator). First motor 748 and second motor 752 are configured to move (specifically, rotate) first mirror 746 and second mirror 750, respectively, in response to signals received from controller 726 to deflect EM radiation 740 from melt pool 722 to first optical detector 738. First mirror 746 and second mirror 750 may have any suitable configuration that enables first mirror 746 and second mirror 750 to deflect EM radiation 740 generated by melt pool 722. In some embodiments, one or both of first mirror 746 and second mirror 750 includes a reflective coating that has a reflectance spectrum that corresponds to EM radiation that first optical detector 738 is configured to detect.

Although second scanning device 742 is illustrated and described as including two mirrors and two motors, second scanning device 742 may include any suitable number of mirrors and motors that enable optical system 720 to function as described herein. Further, second scanning device 742 may include any suitable scanning device that enables optical system 720 to function as described herein, such as, for example, two-dimension (2D) scan galvanometers, three-dimension (3D) scan galvanometers, and dynamic focusing galvanometers.

Mobile build platform module 606 and build plate 712 are configured to operate with multiple DMLM systems 710. As such, build plate 312 must be aligned with DMLM system 710 each time mobile build platform module 606 and build plate 712 are coupled to DMLM system 710. Alignment system 723 is configured to align build plate 712 with DMLM system 710. Alignment system 723 includes a second optical detector 754 and a plurality of fiducial marks 758 on a bottom side 702 of build plate 712. In the exemplary embodiment, build plate 712 includes three fiducial marks 758. However, build plate 712 may include any number of fiducial marks 758 which enable alignment system 723 to operate as described herein.

Alignment system 723 is configured to align build plate 712 with DMLM system 710. Alignment system 723 includes a second optical detector 754 and a fiducial marks projector 756. Fiducial marks projector 756 projects a plurality of fiducial marks 758 on build plate 712. In the exemplary embodiment, fiducial marks projector 756 projects three fiducial marks 758. However, fiducial marks projector 756 may project any number of fiducial marks 758 which enables alignment system 723 to operate as described herein. Each fiducial mark 758 includes a shape projected onto build plate 712 by fiducial marks projector 756. Fiducial marks projector 756 includes a plurality of lasers (not shown) which project fiducial marks 758 onto build plate 712.

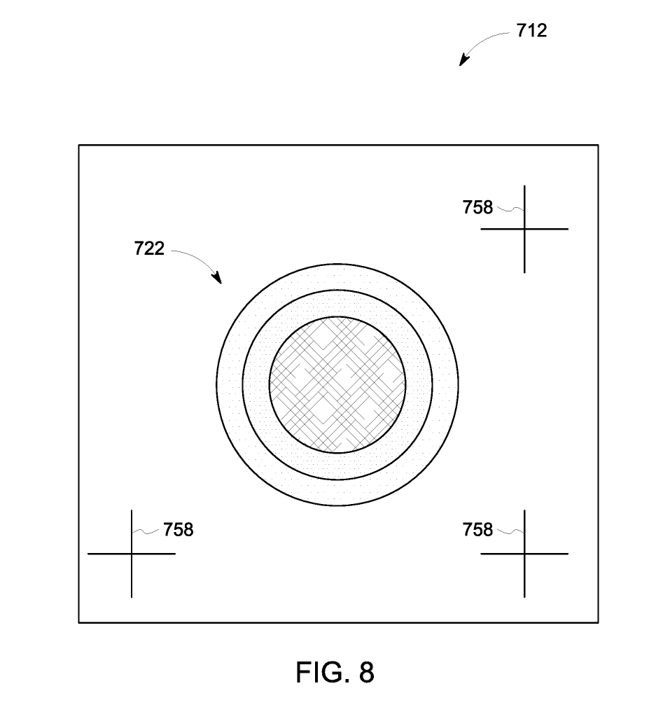

FIG. 8 is a schematic view of build plate 712 of DMLM system 710. In the exemplary embodiment, build plate 712 has a rectangular shape. In other embodiments, build plate 712 may have any suitable size and shape that enables DMLM system 710 to function as described herein. Fiducial marks 758 are projected onto build plate 712. In the exemplary embodiment, fiducial marks 758 have a cross shape. In other embodiments, the shape of fiducial marks 758 may include a circle shape, a triangle shape, or any shape which enables alignment system 723 to operate as described herein. Additionally, fiducial marks 758 may include a grid pattern, a pattern of dots, a checkerboard pattern, or any other pattern which enables alignment system 723 to operate as described herein. Fiducial marks 758 are moveable along build plate 712. More specifically, the position of fiducial marks 758 can be adjusted using fiducial marks projector 756. Additionally, the size and shape of fiducial marks projector 756 may be adjusted using fiducial marks projector 756.

As shown in FIG. 7, second optical detector 754 is configured to detect the position of fiducial marks 758 on build plate 712, and generate an electrical signal 762 in response thereto. Second optical detector 754 is configured to detect the position of fiducial marks 758 on build plate 712 through first scanning device 718 while fiducial marks projector 756 does not project fiducial marks 758 through first scanning device 718. Second optical detector 754 is aligned with laser beam 716. Thus, second optical detector 754 detects the position of build plate 712 relative to DMLM system 710. Second optical detector 754 is communicatively coupled to computing device 724, and is configured to transmit electrical signal 762 to computing device 724. Computing device 724 generates a control signal 760 to controller 726 which controls the alignment of build plate 712 within DMLM system 710, the alignment of first scanning device 718, and alignment of mirror 734. Controller 726 aligns build plate in response to the position of fiducial marks 758 by changing the position of build plate 712, first scanning device 718, and mirror 734. Thus, build plate 712 is capable of moving to, and alignment within, different DMLM systems 710.

In the exemplary embodiment, second optical detector 754 is coupled to laser device 714 such that second optical detector 754 observes fiducial marks 758 relative to laser device 714. Additionally, fiducial marks projector 756 is coupled to build plate 712 such that fiducial marks 758 are projected onto build plate 712 at the same location. In another embodiment, second optical detector 754 is coupled to build plate 712 such that second optical detector 754 observes fiducial marks 758 relative to build plate 712. Additionally, fiducial marks projector 756 is coupled to laser device 714 such that fiducial marks 758 are projected onto build plate 712 at the same location relative to laser device 714.

Computing device 724 may be a computer system that includes at least one processor (not shown in FIG. 3) that executes executable instructions to operate DMLM system 710. Computing device 724 may include, for example, a calibration model of DMLM system 710 and an electronic computer build file associated with a component, such as component 728. The calibration model may include, without limitation, an expected or desired melt pool size and temperature under a given set of operating conditions (e.g., a power of laser device 714) of DMLM system 710. The build file may include build parameters that are used to control one or more components of DMLM system 710. Build parameters may include, without limitation, a power of laser device 714, a scan speed of first scanning device 718, a position and orientation of first scanning device 718 (specifically, mirror 734), a scan speed of second scanning device 742, and a position and orientation of second scanning device 742 (specifically, first mirror 746 and second mirror 750). In the exemplary embodiment, computing device 724 and controller 726 are shown as separate devices. In other embodiments, computing device 724 and controller 726 may be combined as a single device that operates as both computing device 724 and controller 726 as each are described herein.

In the exemplary embodiment, computing device 724 is also configured to operate at least partially as a data acquisition device and to monitor the operation of DMLM system 710 during fabrication of component 728. In one embodiment, for example, computing device 724 receives and processes electrical signals 744 from first optical detector 738. Computing device 724 may store information associated with melt pool 722 based on electrical signals 744, which may be used to facilitate controlling and refining a build process for DMLM system 710 or for a specific component built by DMLM system 710.

Further, computing device 724 may be configured to adjust one or more build parameters in real-time based on electrical signals 744 received from first optical detector 738. For example, as DMLM system 710 builds component 728, computing device 724 processes electrical signals 744 from first optical detector 738 using data processing algorithms to determine the size and temperature of melt pool 722. Computing device 724 may compare the size and temperature of melt pool 722 to an expected or desired melt pool size and temperature based on a calibration model. Computing device 724 may generate control signals 760 that are fed back to controller 726 and used to adjust one or more build parameters in real-time to correct discrepancies in melt pool 722. For example, where computing device 724 detects discrepancies in melt pool 722, computing device 724 and/or controller 726 may adjust the power of laser device 714 during the build process to correct such discrepancies.

Controller 726 may include any suitable type of controller that enables DMLM system 710 to function as described herein. In one embodiment, for example, controller 726 is a computer system that includes at least one processor and at least one memory device that executes executable instructions to control the operation of DMLM system 710 based at least partially on instructions from human operators. Controller 726 may include, for example, a 3D model of component 728 to be fabricated by DMLM system 710. Executable instructions executed by controller 726 may include controlling the power output of laser device 714, controlling a position and scan speed of first scanning device 718, and controlling a position and scan speed of second scanning device 742.

Controller 726 is configured to control one or more components of DMLM system 710 based on build parameters associated with a build file stored, for example, within computing device 724. In the exemplary embodiment, controller 726 is configured to control first scanning device 718 based on a build file associated with a component to be fabricated with DMLM system 710. More specifically, controller 726 is configured to control the position, movement, and scan speed of mirror 734 using motor 736 based upon a predetermined path defined by a build file associated with component 728.

In the exemplary embodiment, controller 726 is also configured to control second scanning device 742 to direct EM radiation 740 from melt pool 722 to first optical detector 738. Controller 726 is configured to control the position, movement, and scan speed of first mirror 746 and second mirror 750 based on at least one of the position of mirror 734 of first scanning device 718 and the position of melt pool 722. In one embodiment, for example, the position of mirror 734 at a given time during the build process is determined, using computing device 724 and/or controller 726, based upon a predetermined path of a build file used to control the position of mirror 734. Controller 726 controls the position, movement, and scan speed of first mirror 746 and second mirror 750 based upon the determined position of mirror 734. In another embodiment, first scanning device 718 may be configured to communicate the position of mirror 734 to controller 726 and/or computing device 724, for example, by outputting position signals to controller 726 and/or computing device 724 that correspond to the position of mirror 734. In yet another embodiment, controller 726 controls the position, movement, and scan speed of first mirror 746 and second mirror 750 based on the position of melt pool 722. The location of melt pool 722 at a given time during the build process may be determined, for example, based upon the position of mirror 734.

Controller 726 may also be configured to control other components of DMLM system 710, including, without limitation, laser device 714. In one embodiment, for example, controller 726 controls the power output of laser device 714 based on build parameters associated with a build file.

Embodiments of the multiple build station additive manufacturing system with an air-locked input chamber described herein build a component with multiple build areas in an air-locked chamber. The multiple build area additive manufacturing system includes an air-locked build chamber, a conveyor system, a plurality of operation stations, an air locked input chamber, and an air-locked exit chamber. The operation stations are positioned adjacent to the conveyor system within the air-locked build chamber. A build platform enters the air-locked input chamber and the atmosphere in the air-locked input chamber purged with inert gas. Then the build platform enters the air-locked build chamber and is positioned on the conveyor system. The conveyor system transports the build platform from operational station to operational station. Each operational station performs a task on build powder on the build platform. Once the operation stations have completed a component on the build platform, the build platform exits the air-locked build chamber through the air-locked exit chamber. Building a component with multiple build stations in a single air-locked build chamber decreases build time and costs.

Additionally, embodiments of the mobile purging station described herein purge air-locked build chambers of multiple direct metal laser melting (DMLM) systems. The mobile purging station includes a source of inert gas and a compressor. During operations, the compressor channels the inert gas into the sealed air-locked build chamber. The inert gas displaces the atmospheric oxygen in the air-locked build chamber. After the mobile purge unit has purged a first DMLM system, the mobile purge unit can purge other DMLM systems while the first DMLM system is constructing a component. Mobile purge stations reduce the cost of DMLM systems by eliminating a dedicated purge station on each DMLM system. Additionally, mobile purge stations may have larger, more powerful compressors which can purge the air-locked build chamber faster than a smaller, less powerful dedicated purge station. Thus, mobile purge stations decrease the build time of a component.

Additionally, embodiments of the centralized inert gas purging station for build platform modules described herein purge mobile build platform modules of multiple direct metal laser melting (DMLM) systems. DMLM systems are separated into two chambers with contained gas environments, a mobile build platform module and an integration module. The integration module includes a laser scanner and a powder-dispensing unit. The integration module maintains an inert environment throughout the entire process. During operations, a build plated is loaded into the mobile build platform module. A centralized inert gas purging station purges the mobile build platform module with inert gas. The mobile build platform module is coupled to the integration module and the powder-dispensing unit dispenses powder to a build plate within the mobile build platform module. The laser scanner builds a component in the mobile build platform module and the mobile build platform module is decoupled from the integration module. The centralized inert gas purging station reduces the cost of DMLM systems by eliminating a dedicated purge station on each DMLM system. Additionally, centralized inert gas purging station may have larger, more powerful compressors which can purge the mobile build platform module faster than a smaller, less powerful dedicated purge station. Thus, centralized inert gas purging station decrease the build time of a component.

An exemplary technical effect of the methods and systems described herein includes: (a) containing multiple DMLM systems within a single air-locked chamber; (b) moving a build plate to multiple DMLM systems within the air-locked chamber; (c) detecting the position of the fiducial marks on the build plate; (d) aligning the build plate with a DMLM system; (e) moving a build plate to another DMLM system with a conveyance system; (f) decreasing the build time of a component; (g) moving a purge station to multiple DMLM systems; (h) purging the air-locked build chamber of multiple DMLM Systems; (i) decreasing the cost of a DMLM system; (j) decreasing the build time of a component; (k) coupling a mobile build platform module to a centralized inert gas purging station; (l) purging the mobile build platform module with inert gas; (m) coupling a mobile build platform module to a DMLM system; (n) decreasing the cost of a DMLM system; and (o) decreasing the build time of a component.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

Exemplary embodiments of multiple build station additive manufacturing systems having an air-locked input chamber, the mobile purging stations, and the centralized inert gas purging station for build platform modules are described above in detail. The apparatus, systems, and methods are not limited to the specific embodiments described herein, but rather, operations of the methods and components of the systems may be utilized independently and separately from other operations or components described herein. For example, the systems, methods, and apparatus described herein may have other industrial or consumer applications and are not limited to practice with additive manufacturing systems as described herein. Rather, one or more embodiments may be implemented and utilized in connection with other industries.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An additive manufacturing system including a build plate with a powdered metal material disposed thereon, said additive manufacturing system comprising:
at least one wall defining an air-locked build chamber;
a conveyor system disposed within said air-locked build chamber, said conveyor system configured to transport the build plate; and
a plurality of operation stations positioned adjacent to said conveyor system within said air-locked build chamber, wherein each operation station of said plurality of operation stations configured to facilitate execution of at least one additive manufacturing operation on the powdered metal material disposed on the build plate, wherein said conveyor system is configured to transfer the build plate from a first operation station of said plurality of operation stations to a second operation station of said plurality of operation stations.

2. The additive manufacturing system in accordance with claim 1, wherein said air-locked build chamber and said conveyor system are configured in a linear configuration.

3. The additive manufacturing system in accordance with claim 1, wherein said air-locked build chamber and said conveyor system are configured in a circular configuration.

4. The additive manufacturing system in accordance with claim 1 further comprising at least one wall defining an air-locked input chamber.

5. The additive manufacturing system in accordance with claim 1 further comprising at least one wall defining an air-locked exit chamber.

6. The additive manufacturing system in accordance with claim 1, wherein at least one operation station of said plurality of operation stations comprises a direct metal laser melting system.

7. The additive manufacturing system in accordance with claim 1, wherein at least one operation station of said plurality of operation stations comprises a powder removal system.

8. A mobile purge station configured to be coupled in flow communication with an additive manufacturing system, the additive manufacturing system including at least one wall defining an air-locked build chamber, said mobile purge station comprising:
a vessel configured to contain an inert gas, said vessel coupled in flow communication with the air-locked build chamber; and
a transportation device configured to transport said vessel to the additive manufacturing system, wherein said vessel is configured to channel the inert gas into the air-locked build chamber.

9. The mobile purge station in accordance with claim 8 further comprising a compressor coupled in flow communication with said vessel and the air-locked build chamber.

10. The mobile purge station in accordance with claim 9, wherein said compressor is configured to compress the inert gas.

11. The mobile purge station in accordance with claim 8, wherein said transportation device comprises a cart.

12. The mobile purge station in accordance with claim 8, wherein said inert gas comprises argon.

13. The mobile purge station in accordance with claim 8, wherein said vessel comprises a gas cylinder.

14. The mobile purge station in accordance with claim 8 further comprising a hose coupled to said vessel and the air-locked build chamber.

15. An additive manufacturing system comprising:
a laser device configured to generate a laser beam;
at least one wall defining an air-locked build chamber;
a build plate having a position relative to said laser device, said build plate disposed within said air-locked build chamber;
a first scanning device configured to selectively direct the laser beam across said build plate, wherein the laser beam generates a melt pool in said build plate; and
a mobile purge station comprising:
a vessel configured to contain an inert gas, said vessel coupled in flow communication with said air-locked build chamber; and
a transportation device configured to transport said vessel to said air-locked build chamber, wherein said vessel is configured to channel the inert gas into said air-locked build chamber.

16. An additive manufacturing facility comprising:
at least one mobile build platform module;
a centralized inert gas purging station configured to purge said at least one mobile build platform module with an inert gas; and
at least one additive manufacturing system, wherein said at least one additive manufacturing system is configured to build a solid component within said at least one mobile build platform module.

17. The additive manufacturing facility in accordance with claim 16 further comprising a central powder distribution system configured to transfer a powder material to said at least one additive manufacturing system.

18. The additive manufacturing facility in accordance with claim 17, wherein said at least one additive manufacturing system comprises an integration module.

19. The additive manufacturing facility in accordance with claim 18, wherein said integration module encloses a direct metal laser melting system.

20. The additive manufacturing facility in accordance with claim 16, wherein said plurality of mobile build platform modules comprise a build plate.

21. The additive manufacturing facility in accordance with claim 16, wherein said inert gas comprises argon.
